(19) United States
(12) Patent Application Publication
(10) Pub. No.: US 2010/0276082 A1
(43) Pub. Date: Nov. 4, 2010

(54) METHOD FOR MANUFACTURING A FIBER-REINFORCED COMPOSITE SABOT WITH IMPROVED INTERFACIAL CHARACTERISTICS BY USING SHORT FIBER

(76) Inventors: In-Seo Park, Daejeon-si (KR); Jin-Seok Kim, Daejeon-si (KR); Seung-Un Yang, Changwon-si (KR); Young-Jun Jeon, Gimhae-si (KR)

Correspondence Address: CAHN & SAMUELS LLP, 1100 17th STREET NW, SUITE 401, WASHINGTON, DC, 20036, US

(21) Appl. No.: 12/236,056

(22) Filed: Sep. 23, 2008

(30) Foreign Application Priority Data
Oct. 31, 2007 (KR) 10-2007-0109930

(51) Int. Cl. B32B 37/02

(52) U.S. Cl. 156/276

(57) ABSTRACT

Disclosed is a method for manufacturing a fiber-reinforced composite sabot for use in APFSDS (Armor Piercing Fin Stabilized Discarding Sabot) which has improved strength to weight ratio with low weight and high strength by using one-directional fiber prepreg ply lamination method. In order to prevent delamination of the radially laminated composite sabot, short fibers are deposited on the interfacial plane thereby spreading the expansion force to fiber as well as the resin.

### CROSS-REFERENCE TO RELATED APPLICATIONS

This application claims priority to Republic of Korea application number 10-2007-0109930, filed on Oct. 31, 2007, which is hereby incorporated by reference in its entirety

### TECHNICAL FIELD

The present invention relates to a method for manufacturing a composite sabot, and more specifically, to a method for manufacturing a fiber-reinforced composite sabot for use in APFSDS (Armor Piercing Fin Stabilized Discarding Sabot) wherein short fibers are deposited on the interface of material in order to improve adhesiveness of material in order to prevent prepreg delamination phenomenon in the circumferential direction caused by the radial lamination.

### PRIOR ARTS

Aluminum alloy is generally used for manufacturing the sabot for the APFSDS which is used for antitank guns. However, by using the high-strength fabric-reinforced composite material having lower density than the aluminum on the sabot, the speed of the shell can be increased with the same energy thereby enhancing the power of the shell. Therefore wide range of research has been made in the field to manufacture lighter and better sabot by replacing the metal sabot with polymer based fiber-reinforced material having specific strength.

The sabot is combined to the outer diameter of the penetrator with three separated pieces and guides the sabot in the gun barrel, delivers the propulsive force to the penetrator, and is separated from the penetrator after the penetrator is propelled from the barrel playing the role of structurally supporting the sabot and preventing leakage of pressure from the barrel. Therefore the weight of the sabot is very important in improving the performance of the whole system, so by making the sabot as light as possible, more of propulsive force is delivered to the penetrator ensuring stable flight of the penetrator.

Also, in order to deliver the propulsive force to the penetrator more efficiently, inner part of the sabot is formed a concave-convex combining surface in the form of spiral or groove in the contacting surface with the penetrator. The outer part of the sabot is formed so that the sabot closely contact the barrel sealing the barrel so that the pressure for the propulsive force is maintained. After the penetrator is separated from the barrel, the sabot is separated from the penetrator through friction with the air without affecting the propulsion of the penetrator.

FIG. 6 shows the cross section of the conventional aluminum sabot which shows that the sabot 3 is composed of three pieces and combined with the penetrator 2 of the APFSDS in the barrel 1 of the tank or armored vehicle. Between the outer part of the penetrator 2 and the inner part of the corresponding sabot 3, is formed a concave-convex combining part 2a, 3a in the form of spiral or groove, and this concave-convex combining part 2a, 3a is formed not to be damaged considering the shearing stress from the propulsion force.

The sabot made by the conventional method is made from aluminum and although presents no problem in endurance considering the shearing stress required at the time of propulsion, relatively high weight compared to the composite sabot causes problem in important properties of the penetrator such as aviation velocity, penetration strength on the target and other overall properties of the system.

Also, since lamination in the radial direction has been reportedly adopted since the conventional lamination method in axial or circumferential direction cannot obtain the required mechanical strength of the groove. Lamination in the radial direction uses prepreg made of unidirectional fiber or fabric fiber/resin, and prepreg ply is laminated in orthogonal direction on the groove surface contacting the penetrator providing much improved shear strength compared to the above mentioned conventional lamination method in axial or circumferential direction. However, while the required strength in the same or orthogonal direction of the contacting the penetrator is obtained in the radial direction lamination, there is a problem of low adhesive strength in the direction in which the prepreg ply is laminated, and so there has been need for developing technology that can improve this strength.

Until recently, the patent application relating radial directional lamination has been directed to the lamination technology or orientation of the fiber, for example U.S. Pat. No. 5,640,054 (Sabot segment molding apparatus and method for molding a sabot segment), and U.S. Pat. No. 5,789,699 (Composite ply architecture for sabot) and U.S. Pat. No. 6,125,764 (Simplified tailored composite architecture).

The method of using high strength resin can be considered in order to reinforce the material property in the laminating direction, but the cost will be increased due to the high price of the material and complex manufacturing method.

The previous composite sabots manufactured only in the radial or circumferential laminating method generated the delamination phenomenon from the severe bending of fiber. Accordingly, applying the band lamination and the hoop lamination on the external layer of radial lamination made it possible to endure from the high expansion power to operate in the circumference direction in shooting the shells. Also the lamination improving the previous segment lamination shape made the surface of 120° not to be damaged in the process of sabots.

### OBJECTIVE OF THE INVENTION

The present invention has been designed to solve the above mentioned problems of prior arts. In order to prevent delamination of the radially laminated composite sabot, short fibers are deposited at every stage of manufacturing on the interfacial plane of material thereby spreading the expansion force in the circumferential direction to fiber as well as to the resin. In this way, the adhesiveness of the sabot in the circumferential direction is enhanced and novel method for manufacturing a composite sabot can be developed that can protect the sabot from high pressure of explosion and can ensure unstable separation of the sabot thereby enhancing the performance and reproducibility of the sabot.

### DISCLOSURE OF THE INVENTION

To solve the above problems of the prior arts, the present invention provides a method for manufacturing a fiber-reinforced composite sabot by laminating the prepreg fiber in the radial direction comprising a sub-segment forming step wherein four or more of sub-segments are formed with predetermined form by superposing a plurality of plies; a segment forming step wherein three or more of segments are formed by laminating said sub-segments; a piece forming step wherein three pieces are formed by laminating said segments; and a sabot forming step wherein a sabot is formed by combining said three pieces; the sub-segment forming step further comprises forming preliminary laminated board by superposing a plurality of plies and forming a sub-segment by cutting the preliminary laminated board into a predetermined form wherein the step of forming preliminary laminated board includes forming a preliminary laminated board by depositing a short fiber between each ply when laminating a plurality of plies.

Also it is preferable that the segment forming step includes forming a segment by depositing a short fiber between each sub-segment when laminating sub-segments.

Also preferably the segment forming step can further comprise depositing a short fiber on the inclined plane of the laminated sub-segment and further laminating reinforcement sub-segment.

Further, the piece forming step can include forming a piece by depositing a short fiber between each segment when laminating segments.

Finally, the short fiber can be one or more of fiber selected from the group consisting of carbon fiber, graphite fiber and glass fiber, and the prepreg fiber material laminated in the radial direction is one or more of fiber selected from the group consisting of carbon fiber, graphite fiber and glass fiber, and the fiber prepreg fiber material is thermosetting or thermoplastic resin.

### INDUSTRIAL EFFECT

According to the method for manufacturing a fiber-reinforced composite sabot with improved interfacial characteristics by using short fiber, the weight of the sabot can be reduced by 30% compared to conventional aluminum sabot. By improving the adhesiveness in the radial direction by depositing short fiber, the sabot is protected from the expansion pressure resulting from the high impact energy inside the barrel, providing optimal design requirement that can endure the destructing force of the sabot.

### BRIEF DESCRIPTION OF DRAWINGS

FIG. 1 is a perspective view of carbon fiber ply.

FIG. 2a is a perspective view showing a plurality of plies composing a preliminary lamination plate.

FIG. 2b is a cross-sectional view showing a plurality of plies composing a preliminary lamination plate.

FIG. 3a shows the configuration of the sub-segment composing a segment.

FIG. 3b is a cross sectional view showing laminated sub-segment.

FIG. 3c is a perspective view of a segment composing a piece.

FIG. 4a is a perspective view showing the piece composing a sabot.

FIG. 4b is a cross sectional view showing the piece composing a sabot.

FIG. 5 is a perspective view showing the appearance of the sabot.

FIG. 6 is a longitudinal cross sectional view of conventional sabot configuration.

### DESCRIPTION ON THE NUMERAL OF THE DRAWINGS

10: basic plate
20: release plate
30: carbon fiber prepreg ply
40: preliminary laminating plate
50: reinforcement short fiber
60: resin
70: sub-segment
71: reinforcement sub-segment
80: segment
90: piece
100: guiding line in laminating in the composite sabot
110: distribution of propulsive force in the barrel
120: fiber reinforced composite sabot

### BEST MODE

Example of the present invention will be described with reference to the drawings attached.

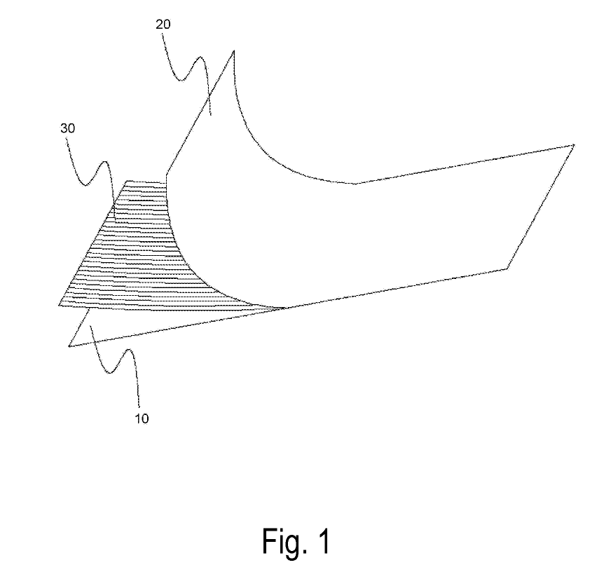

In the perspective view of FIG. 1, fiber prepreg ply 30 is illustrated along with basic plate 10 and release plate 20. The material of the fiber prepreg ply 30 is thermosetting or thermoplastic resin and one or more of fiber chosen from the group of carbon fiber, graphite fiber or glass fiber is used as a fiber.

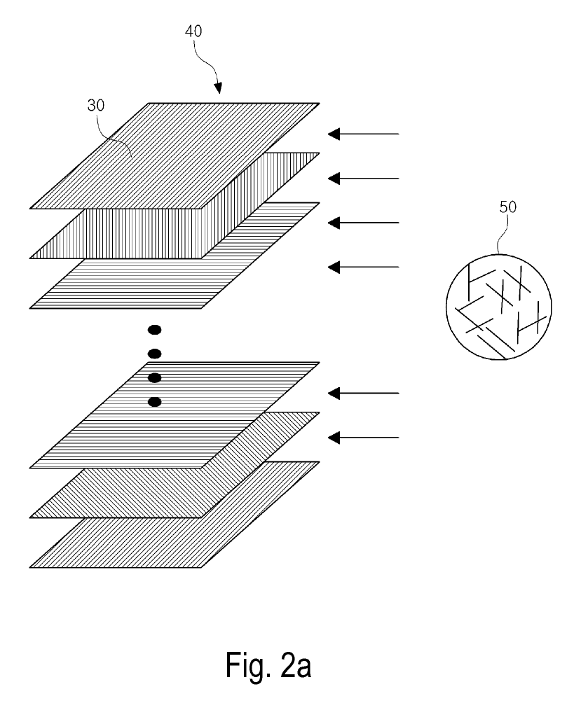

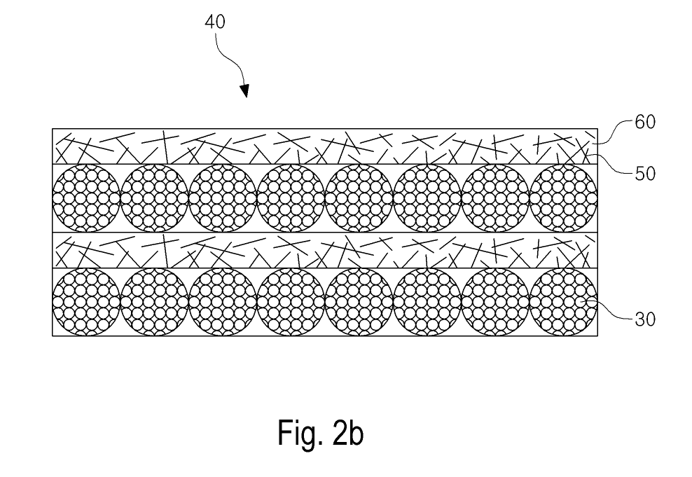

Basic plate 10 and release plate 20 are separated from the fiber prepreg ply 30 produced, and two or more of plies 30 are laminated in the order considering the angle of orientation as shown in FIG. 2a. By depositing short fiber 50 between the plies when laminating plies, the adhesiveness of the material, in addition to the inherent adhesiveness of the ply, is enhanced from the step of laminating preliminary laminating plate 40. Thus laminated preliminary laminating plates 40 are closely attached each other as shown in FIG. 2b. The short fiber 50 is not deposited between the plies not by itself but included in the resin thereby forming a layer of resin 60 including a short fiber. The plurality of plies thus attached has improved adhesiveness between the plies 30 compared with the conventional sabot composed of resin layers only.

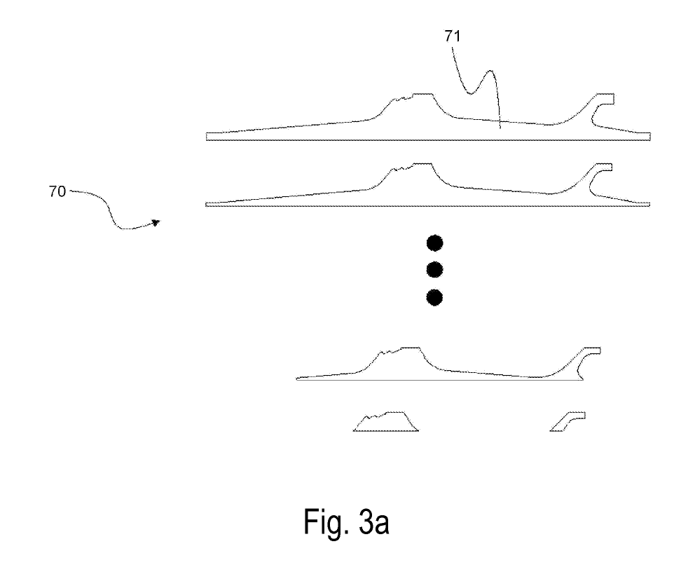

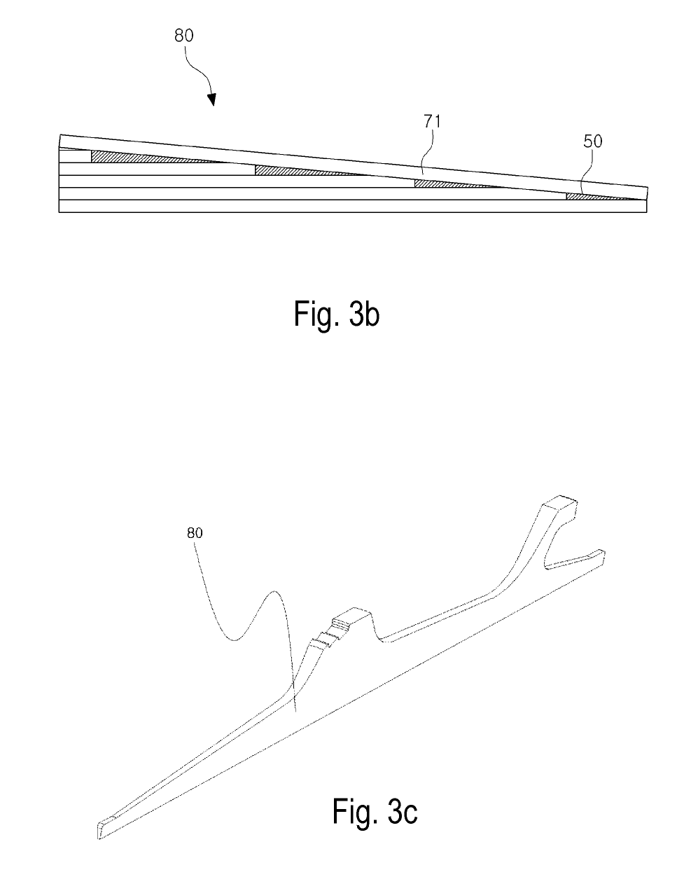

This superposed plies can be used to form a sub-segment with predetermined form, or, more preferably, can be used to form a preliminary laminating plate 40 by superposing a plurality of plies as shown in FIG. 2a and FIG. 2b and can be used to form a variety forms of sub-segment 70 by cutting the preliminary laminating plate 40 through cutter as shown in FIG. 3a.

The sub-segment thus formed is laminated into the form of segment 80 shown in FIG. 3b and FIG. 3c by depositing the short fiber 50 between each sub-segment by using predetermined lamination method. More specifically, continuous form of sub-segment 70 except the reinforcement sub-segment 71 is laminated in the order as shown in FIG. 3b, and short fiber 50 is sufficiently deposited on the inclined surface, the surface of stairs composed of each sub-segment 70, and then the reinforcement sub-segment 71 is further deposited. FIG. 3c illustrates the appearance of the segment formed in this way. Thus, the bending of the fiber is prevented by sufficiently depositing the short fiber 50 on the contacting surface of the segment 80 and reinforcement sub-segment 71.

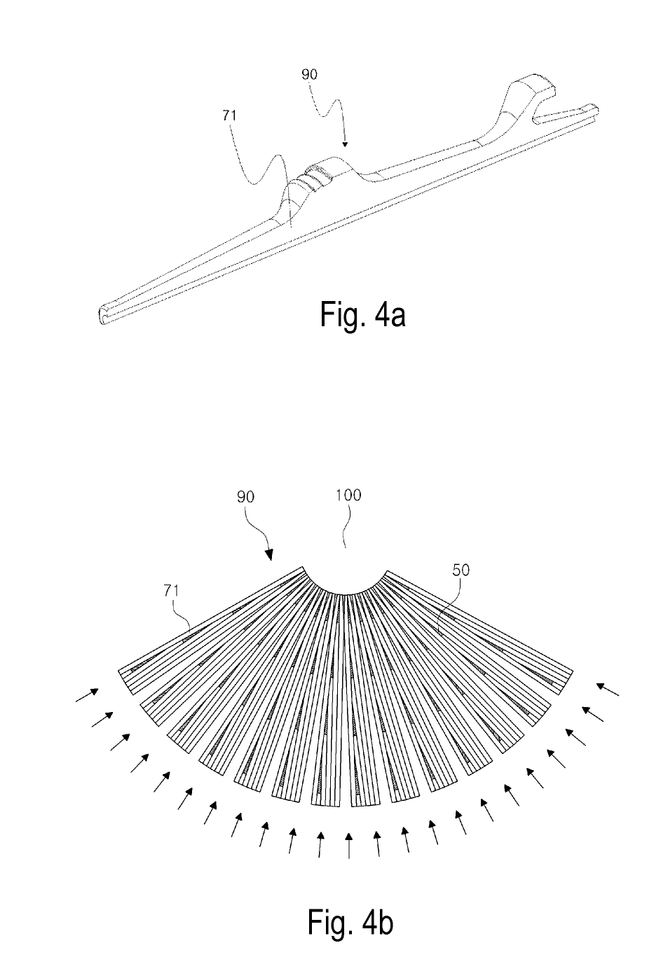

In a continuous way, the short fiber 50 is deposited again on the surface of the reinforcement sub-segment 71 of each segment 80, and other segment 80 is laminated by attaching to form the piece 90 shown in FIG. 4a. It should be noted that the segments 80 are laminated and contacting each other although the segment 80 forming the piece 90 is shown in FIG. 4b to have some distance with the neighboring segment 80 to emphasize the construction of the segment.

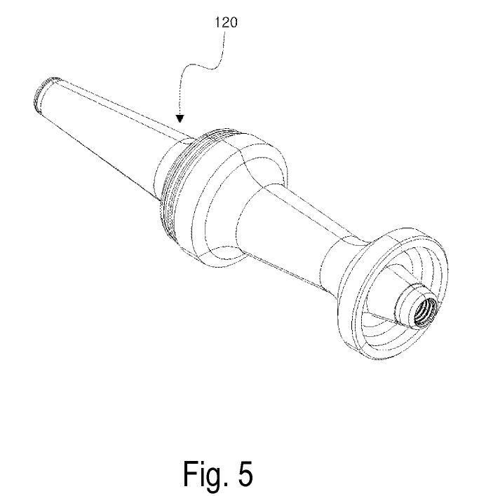

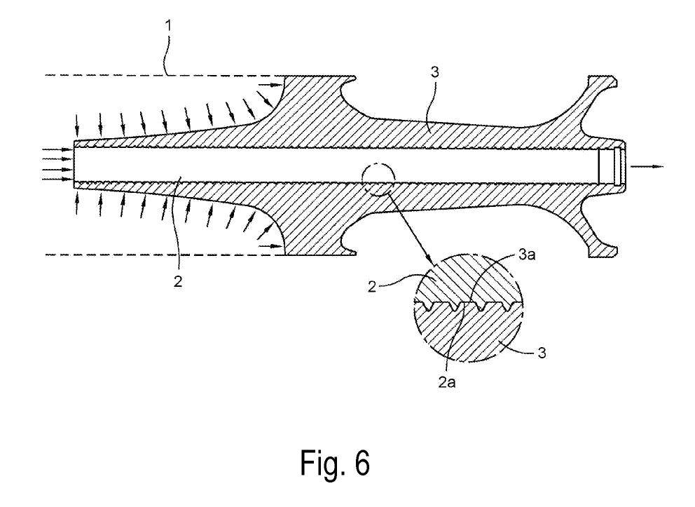

The piece 90 composed of segment 80 as shown in FIG. 4(b) is formed with the longitudinal cross section in the form of fan-shaped form, and guiding line 100 passing through the center in the sabot 120 of FIG. 5 is shown as a dotted line in FIG. 4b. Therefore, three or more of segments 80 are formed by laminating the sub-segments 70 which are cut in a variety form in FIG. 3(a) according to the guide line 100 and a plurality of segments are laminated to form a piece 90 having a 120 degree surface. The numeral 110 which is not described illustrates the distribution of propulsive force on the piece 90 in the barrel.

Lastly, the three pieces 140 prepared by the above method is inserted into press mold to form fiber reinforced composite sabot 160 as shown in FIG. 7 and the forming process is carried out to closer and firmer forming by choosing appropriate pressure and temperature in the molding.

In the composite sabot laminated in this way, the expansion force which has been applied to the resin only is spread among the fabric and the required mechanical strength is met so that the delamination due to the explosive pressure 110 from the barrel can be prevented.

Although the preferable example of the present invention has been described above, it should be understood not to limit the scope of the present invention and any modification can be possible to those skilled in the art within the scope of the claims.

What is claimed is:

1. A method for manufacturing a fiber-reinforced composite sabot by laminating the prepreg fiber in the radial direction comprising:
a sub-segment forming step wherein four or more of sub-segments are formed with predetermined form by superposing a plurality of plies;
a segment forming step wherein three or more of segments are formed by laminating the sub-segments;
a piece forming step wherein three pieces are formed by laminating the segments; and
a sabot forming step wherein a sabot is formed by combining the three pieces;
the sub-segment forming step further comprising the step of forming a preliminary laminating board by superposing a plurality of plies and the step of forming a sub-segment by cutting the preliminary laminating board into a predetermined form wherein the step of forming a preliminary laminating board includes forming a preliminary laminating board by depositing a short fiber between each ply when laminating a plurality of plies.

2. The method for manufacturing a fiber-reinforced composite sabot of claim 1 wherein the segment forming step includes the step of forming a segment by depositing a short fiber between each sub-segment when laminating sub-segments.

3. The method for manufacturing a fiber-reinforced composite sabot of claim 2 wherein the segment forming step further comprises the step of depositing sufficient short fiber on the inclined plane of the laminated sub-segment and further laminating reinforcing sub-segment.

4. The method for manufacturing a fiber-reinforced composite sabot of claim 1 wherein the piece forming step includes the step of forming a piece by depositing a short fiber between each segment when laminating segments.

5. The method for manufacturing a fiber-reinforced composite sabot of claim 1 wherein the short fiber is one or more of fiber selected from the group consisting of carbon fiber, graphite fiber and glass fiber, and the prepreg fiber material laminated in the radial direction is one or more of fiber selected from the group consisting of carbon fiber, graphite fiber and glass fiber, and the fiber prepreg fiber material is thermosetting or thermoplastic resin.

6. The method for manufacturing a fiber-reinforced composite sabot of claim 2 wherein the short fiber is one or more of fiber selected from the group consisting of carbon fiber, graphite fiber and glass fiber, and the prepreg fiber material laminated in the radial direction is one or more of fiber selected from the group consisting of carbon fiber, graphite fiber and glass fiber, and the fiber prepreg fiber material is thermosetting or thermoplastic resin.

7. The method for manufacturing a fiber-reinforced composite sabot of claim 3 wherein the short fiber is one or more of fiber selected from the group consisting of carbon fiber, graphite fiber and glass fiber, and the prepreg fiber material laminated in the radial direction is one or more of fiber selected from the group consisting of carbon fiber, graphite fiber and glass fiber, and the fiber prepreg fiber material is thermosetting or thermoplastic resin.

8. The method for manufacturing a fiber-reinforced composite sabot of claim 4 wherein the short fiber is one or more of fiber selected from the group consisting of carbon fiber, graphite fiber and glass fiber, and the prepreg fiber material laminated in the radial direction is one or more of fiber selected from the group consisting of carbon fiber, graphite fiber and glass fiber, and the fiber prepreg fiber material is thermosetting or thermoplastic resin.
